(19) United States
(12) Patent Application Publication
(10) Pub. No.: US 2026/0203461 A1
(43) Pub. Date: Jul. 16, 2026

(54) METHOD FOR BUILDING AND SEARCHING ADDITIVE MANUFACTURING LIFE CYCLE INTEGRATED DATA ON BASIS OF META-MAPPER

(71) Applicant: Korea Electronics Technology Institute, Seongnam-si (KR)

(72) Inventors: Hye In LEE, Anyang-si (KR); Hwa Seon SHIN, Yongin-si (KR); Jae Ho SHIN, Hanam-si (KR); Sung Hwan CHUN, Seoul (KR)

(73) Assignee: Korea Electronics Technology Institute, Seongnam-si (KR)

(21) Appl. No.: 19/134,624

(22) PCT Filed: Nov. 1, 2023
(86) PCT No.: PCT/KR2023/017213

§ 371 Date: May 30, 2025

(30) Foreign Application Priority Data
Jan. 31, 2023 (KR) 10-2023-0012944

(51) Int. Cl. G06F 30/17; B29C 64/393; B33Y 50/02; G06F 30/23; G06F 113/10; G06F 119/08

(52) U.S. Cl. CPC G06F 30/17; B29C 64/393; G06F 30/23; B33Y 50/02; G06F 2113/10; G06F 2119/08

(57) ABSTRACT

Provided is a method for building and searching additive manufacturing life cycle integrated data on the basis of a meta-mapper. An additive manufacturing data management method according to an embodiment of the present invention involves: collecting pieces of data generated in an additive manufacturing process; storing the collected pieces of data; and mutually mapping the stored pieces of data. Accordingly, the pieces of data generated in the life cycle of the additive manufacturing are integrated, and rapid mutual searching between the pieces of data via a meta-mapper is enabled such that various pieces of data can be shown in combination without delay, and interconnectivity, tendencies, or the like can be easily analyzed through data stratification.

### TECHNICAL FIELD

The disclosure relates to a data management technology, and more particularly, to a method for integrating and storing pieces of data that are generated in the life cycle of additive manufacturing, and managing to enable the pieces of data to be searched in association with one another.

### BACKGROUND ART

Currently, additive manufacturing technologies are developing to the extent that they are applied to mass production as well as prototyping. In a mass production process, production stability should be guaranteed with fewer output failures and output errors.

The additive manufacturing industry is seeking various ways to guarantee production stability, and mainly uses a method of predicting a success rate through an output simulation or checking output errors by process experts through a monitoring system.

However, the output simulation and monitoring covers only a small portion of the numerous data generated in the additive manufacturing, and hence, it is not very helpful to guaranteeing production stability of additive manufacturing due to the limitations of providing fragmentary information.

### DISCLOSURE

### Technical Problem

The disclosure has been developed to solve the above-described problems, and an object of the disclosure is to provide a management method for integrating, building and searching pieces of data that are generated in the life cycle of additive manufacturing, as a solution to enhance production stability of additive manufacturing in the manufacturing industry by reducing additive manufacturing output failures and output errors.

### Technical Solution

According to an embodiment of the disclosure to achieve the above-described object, an additive manufacturing data management method may include: collecting pieces of data that are generated in an additive manufacturing process; storing the collected pieces of data; and cross-mapping the stored pieces of data.

The pieces of data may be generated in respective stages constituting a life cycle of additive manufacturing.

Mapping may include cross-mapping pieces of data that are generated in the same stage, and cross-mapping pieces of data that are generated in different stages.

The pieces of data generated in the respective stages may include at least one of: 3D model information that is generated in a designing stage; output model information, support information that are generated in a pre-processing stage; a process parameter, a tool path, layer information, analysis information that are generated in a slicing stage; output information, image information, environment information, sensor information, log information that are generated in an output stage; and material property information, shape information, quality information that are generated in a post-processing stage.

The 3D model information may include at least one of CAD data, 3D Scan data, a 3D authoring model, the output model information may include at least one of a Size, Geometry, Volume, Face, Vertex, and the support information may include at least one of Support Parameters, Overhang Angle.

The process parameter may include at least one of Laser Power, Scan Speed, the tool path may include at least one of a Path, Hatching Distance, Build Order, the layer information may include at least one of a Layer Thickness, a Layer Area, the analysis information may include at least one of thermal analysis, residual stress analysis, FEM analysis, the output information may include at least one of material information, equipment information, process expert records, the image information may include an output vision image, the environment information may include at least one of Gas, Pressure, Temperature, the sensor information may include a laser heat source sensor, and the log information may include at least one of Build Plate, Laser, Recoater, Feeder.

The material property information may include at least one of strength, hardness, elasticity, toughness, the shape information may include at least one of 3D Scan, X-ray, CT, and the quality information may include Surface Roughness.

The pieces of data may have different data configurations, and the data configurations may include a value, an index, a time (t), x, y, z data, a layer (l).

According to another embodiment of the disclosure, the additive manufacturing data management method may further include: searching pieces of data that are mapped to data selected by a user among the stored pieces of data; and providing the searched pieces of data along with the data selected by the user.

According to still another embodiment of the disclosure, an additive manufacturing data management system may include: a storage unit configured to store pieces of data; and a processor configured to collect pieces of data that are generated in an additive manufacturing process, to store the collected pieces of data in the storage unit, and to cross-map the pieces of data that are stored in the storage unit.

According to yet another embodiment of the disclosure, an additive manufacturing data management method may include: cross-mapping pieces of data that are generated and stored in an additive manufacturing process; searching pieces of data that are mapped to data selected by a user among the stored pieces of data; and providing the searched pieces of data along with the data selected by the user.

According to a further embodiment of the disclosure, an additive manufacturing data management system may include: a storage unit configured to store pieces of data that are generated in an additive manufacturing process; and a processor configured to cross-map the pieces of data stored in the storage unit, to search pieces of data that are mapped to data selected by a user among the stored pieces of data, and to provide the searched pieces of data along with the data selected by the user.

### Advantageous Effects

As described above, according to embodiments of the disclosure, pieces of data generated in the life cycle of additive manufacturing may be integrated, and rapid cross-searching between the pieces of data by a meta-mapper may be enabled such that various pieces of data may be complexly shown on a single screen without delay, and interconnectivity, tendencies, or the like may be easily analyzed through data stratification.

### DESCRIPTION OF DRAWINGS

FIG. 1 is a flowchart provided to explain a data management method according to an embodiment of the disclosure.

FIG. 2 is a view illustrating an additive manufacturing life cycle data system.

FIG. 3 is a view illustrating a configuration of additive manufacturing data.

FIG. 4 is a view illustrating a concept of data cross-mapping by a meta mapper.

FIG. 5 is a view illustrating cross-searching by the meta mapper.

FIGS. 6 and 7 are views illustrating examples of searching/utilizing by using the meta mapper.

FIG. 8 is a view illustrating a configuration of an additive manufacturing data management system according to another embodiment of the disclosure.

### BEST MODE

Hereinafter, the disclosure will be described in more detail with reference to the drawings.

Embodiments of the disclosure provide a method for building additive manufacturing life cycle integrated data based on a meta mapper. The meta mapper may be configured to map a variety of data that is generated in the life cycle of additive manufacturing and to enable bi-directional interconnection search between data.

Additive manufacturing consists of various stages, and, in an embodiment of the disclosure, pieces of data that are generated in the life cycle of additive manufacturing, that is, in all the stages constituting additive manufacturing, may be mapped, so that fast, integrated search is enabled and omni-directional simultaneous analysis of data across the life cycle is enabled.

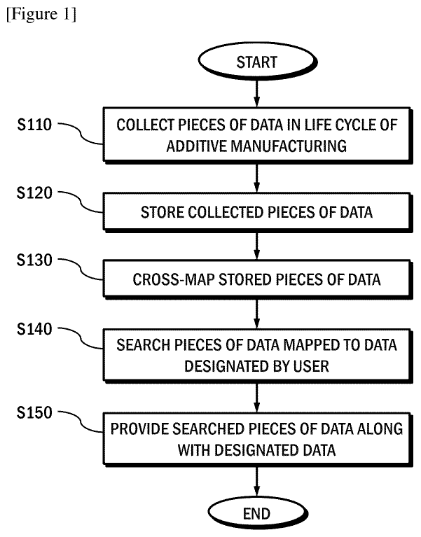

FIG. 1 is a flowchart provided to explain a data management method according to an embodiment of the disclosure. The data management method is a method that collects/stores pieces of data that are generated in the life cycle of additive manufacturing, and maps the data based on a meta mapper, enabling integrated search.

As shown in the drawing, pieces of data that are generated in all the stages of additive manufacturing may be collected, first (S110), and the collected pieces of data may be stored in a database (S120).

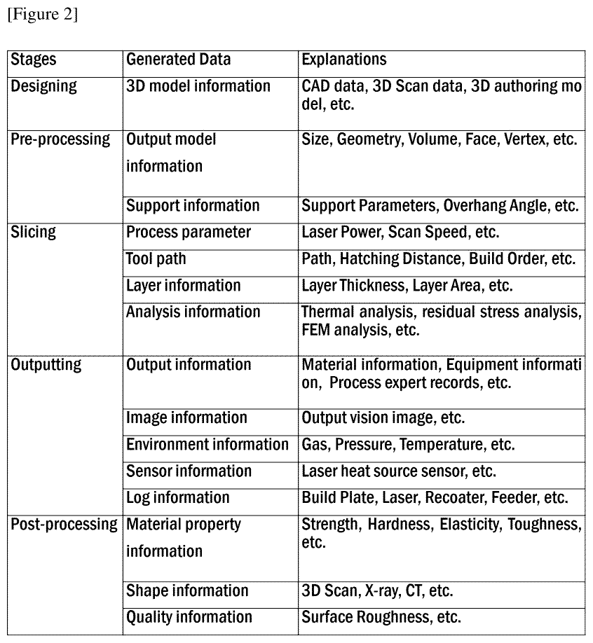

In an embodiment of the disclosure, the stages constituting the life cycle of additive manufacturing may include five stages, designing, pre-processing, slicing, outputting, and post-processing, and pieces of data generated in the respective stages may be established as shown in FIG. 2.
1) In the stage of designing, 3D model information may ge generated. The 3D model information may include CAD data, 3D Scan data, a 3D authoring model, etc.
2) In the stage of pre-processing, output model information, support information may be generated. The output model information may include Size, Geometry, Volume, Face, Vertex, etc., and the support information may include Support Parameters, Overhang Angle, etc.
3) In the stage of slicing, a process parameter, a tool path, layer information, analysis information may be generated. The process parameter may include Laser Power, Scan Speed, etc., and the tool path may include Pach, Hatching Distance, Build Order, etc., the layer information may include Layer Thickness, Layer Area, etc., and the analysis information may include thermal analysis, residual stress analysis, FEM analysis, etc.
4) In the stage of outputting, output information, image information, environment information, sensor information, log information may be generated. The output information may include material information, equipment information, process expert records, etc., the image information may include an output vision image, etc., the environment information may include Gas, Pressure, Temperature, etc., the sensor information may include a laser heat source sensor, etc., and the log information may include Build Plate, Laser, Recoater, Feeder, etc.
5) In the stage of post-processing, material property information, shape information, quality information may be generated. The material property information may include strength, hardness, elasticity, toughness, etc., the shape information may include 3D Scan, X-ray, CT, etc., and the quality information may include Surface Roughness, etc.

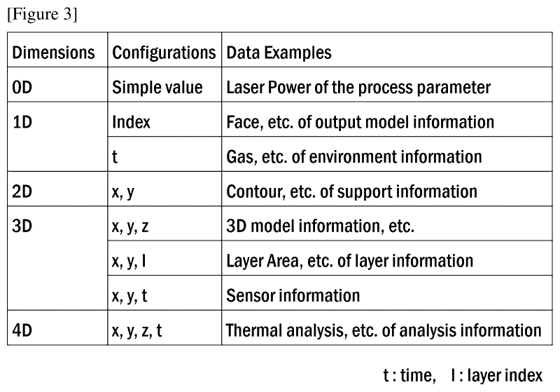

The pieces of data generated in the respective stages of the additive manufacturing mentioned above may have various configurations, and applicable data configurations are illustrated in FIG. 3. As shown in the drawing, the pieces of data may be configured variously from simple values of zero dimension (0D) to 4D having time axes added to 3D coordinates.

Even the data of the same dimension may have different data configurations. For example, 3D may be typically divided into data (3D model information, etc.) which is comprised of x, y, z data, and data (image obtained through a sensor) which is comprised of x, y data and time (t) data.

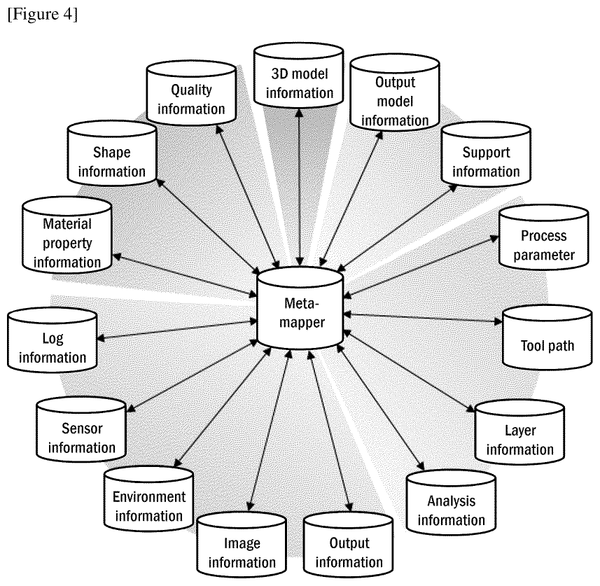

Reference will be made back to FIG. 1. When data collection/storage is completed through steps S110 and S120, the meta mapper may cross-map the stored pieces of data (S130). As shown in FIG. 4, cross-mapping between pieces of data by the meta mapper refers to mutually linking all of the stored pieces of data.

Cross-mapping does not distinguish between the additive manufacturing stages. This means that cross-mapping is performed not only between pieces of data generated in homogenous stages but also between pieces of data generated in heterogenous stages. For example, data in the output stage may be mapped to other data in the output stage as well as to data in the designing stage.

Furthermore, cross-mapping does not distinguish between data configurations (dimensions). This means that cross-mapping is performed not only between data having the same configuration but also between data having different configurations. For example, 1D data may be mapped to 1D data as well as 0D data, 2D data, 3D data, 4D data.

Data mapping by the meta mapper is to link pieces of data generated in the life cycle of additive manufacturing to one another in advance and to build a data organization that enables cross-search.

As shown in FIG. 1, when the cross-mapping is completed through step S130, pieces of data that are mapped (linked) to data designated by the user may be searched (S140), and the searched pieces of data may be provided along with the designated data (S150).

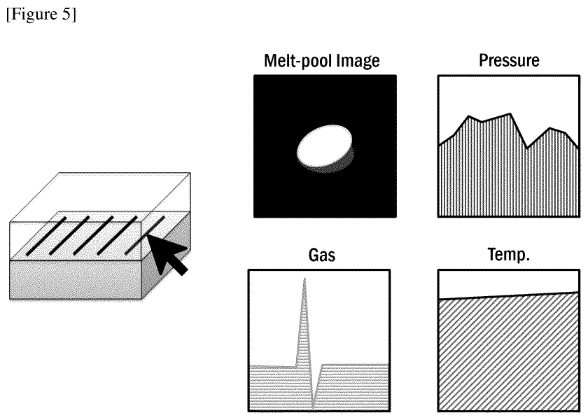

For example, as shown in FIG. 5, when the user selects a path drawn overlaid on the 3D model information, associated Melt-pool Image, Pressure, Gas, Temp, etc. that are mapped to the corresponding path may be cross-searched and provided.

When the cross-searched pieces of data are provided, the pieces of data may be listed on a single screen in a grid pattern or may be shown in a tree form by layering or layered rendering.

Data provision by cross-searching may improve the efficiency of analyzing data correlation by process developers or data scientists in the additive manufacturing, and may provide an opportunity to derive new tendencies between data.

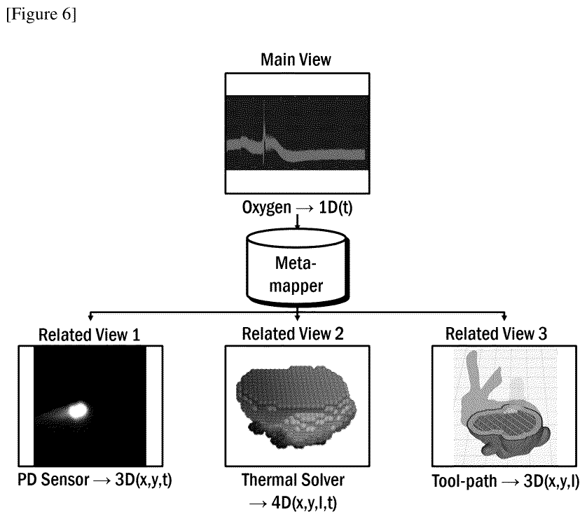

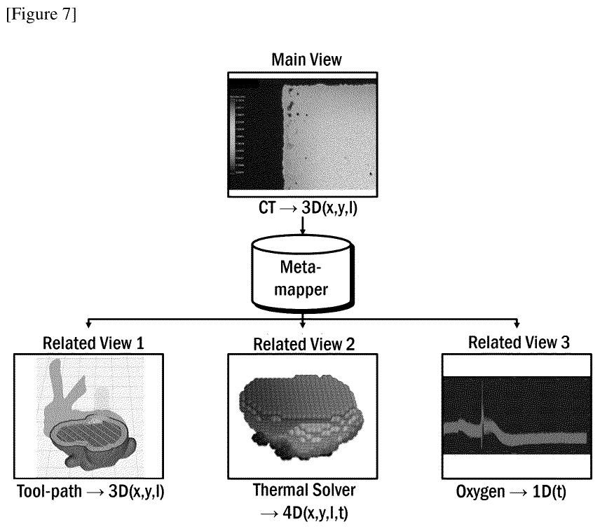

Hereinafter, specific examples of searching/utilizing additive manufacturing data will be described.
1) Example #1 of searching/utilizing by using a meta mapper (FIG. 6)
A process expert may find an anomaly in the oxygen concentration value in the middle of monitoring an additive manufacturing output stage, and may designate/select by clicking the anomaly portion (time-based data) on the oxygen concentration chart (Main View).
The meta mapper may provide a result of integrated searching for additive manufacturing data that is linked with reference to a sensing “time” of the oxygen concentration value selected by the process expert as follows:
[Mapping of 1D (time) and 3D (x, y, time)]: The meta mapper may map sensor values having different sampling periods with reference to an absolute time, and may show the result of mapping (Related View 1).

[Mapping of 1D (time) and 4D (x, y, layer, time)]: The meta mapper may map a result of thermal analysis that matches the time selected by the process expert (Related View 2, x, y, layer values used for the thermal analysis are values that are reset for the corresponding module, and are different from x, y, z values of the 3D model). The time value used for analysis is different from an actual output time, and the meta mapper may map by appropriately compensating for the time value based on log information, a process parameter, a tool path, etc.
[Mapping of 1D (time) and 3D (x, y, layer)]: The meta mapper may show a tool path of the corresponding time by using the process parameter and tool path information with reference to the oxygen concentration selection time (Related View 3).
In addition to the above-described example, the meta mapper may map and provide a variety of other data, and based on this, the process expert may determine that the oxygen concentration anomaly causes an output failure, and may stop the output stage and begins to solve the problem.
2) Example #2 of searching/utilizing by using the meta mapper (FIG. 7)
The process expert may find a plurality of pores (porosity) that influence output quality in a non-destructive test (computed tomography (CT)) in the middle of performing a post-processing stage of additive manufacturing, and may designate/select by clicking the porosity portion in a CT visualization screen (Main View).
The meta mapper may provide a result of integrated searching for related additive manufacturing data with reference to a position of a pore (x, y, l) of a CT image selected by the process expert as follows:
[Mapping of 3D (x, y, layer) and 3D (x, y, z)]: The meta mapper may show a corresponding tool path based on the position of the pore of the CT image (Related View 1, x, y, layer values of the CT image are values corresponding to a resolution of shooting equipment and are different from x, y, z values of an actual 3D model). The meta mapper may map the 3D values of the CT image to the 3D model (x, y, z), and may connect a corresponding tool path by using the corresponding information, process parameter and tool path information.
[Mapping of 3D (x, y, layer) and 4D (x, y, layer, time)]: The meta mapper may map a 3D value that is used for the position of the pore of the CT image to the 3D model, and may be able to search thermal analysis information that is used at the pre-processing stage (Related View 2). The x, y, layer values used in the CT image are different from x, y, layer values used for a thermal analysis module, and should be mapped by the meta mapper by using 3D model information in the middle of mapping.
[Mapping of 3D (x, y layer) and 1D (time)]: The meta mapper may search a corresponding position in the 3D model with reference to the position of the pore in the CT image, and may find an output time at which the pore occurs in the CT image by using the tool path and the process parameter, and may show an oxygen concentration at the corresponding time (Related View 3).
In addition to the above-described example, the meta mapper may map and provide a variety of other data, and based on this, the process expert may analyze that the pore occurring in the CT is caused by overheating, and may correct the process parameter and the tool path and may proceed with re-output.

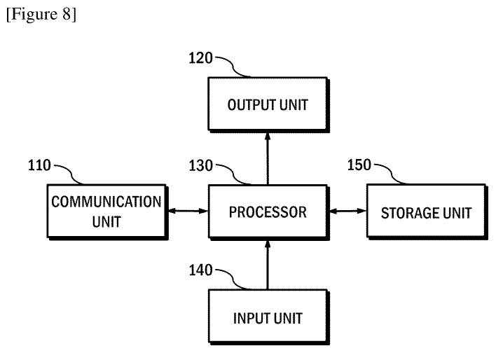

FIG. 8 is a view illustrating a configuration of an additive manufacturing data management system according to another embodiment of the disclosure. The additive manufacturing data management system according to an embodiment of the disclosure may be implemented by a computing system which includes a communication unit 210, an output unit 220, a processor 230, an input unit 240, and a storage unit 250 as shown in the drawing.

The communication unit 210 may be a communication means that is communicatively connected with an external device such as a 3D printer, test equipment, etc., to exchange data and to access an external network.

The processor 230 may perform the procedures shown in FIG. 1 to store life cycle data of additive manufacturing in a data base built in the storage unit 250, and to perform cross-mapping/searching for the data by executing the meta mapper.

The output unit 220 may be a display that displays a result of cross-searching by the processor 230, and the input unit 240 may be a user interface means that receives input of a user command, for example, data designation/selection, and transmits the same to the processor 230.

Up to now, the method for building and searching additive manufacturing life cycle integrated data by the meta mapper has been described in detail with reference to preferred embodiments.

In embodiments of the disclosure, data building and structure for integrating/managing the whole data sets of an additive manufacturing domain may be organized as a solution to improve production stability of additive manufacturing in the manufacturing industry by reducing output failures and output errors in additive manufacturing.

In addition, for built data, rapid cross-searching between data by the meta mapper may be performed, and a layered rendering method may be applied to complexly display a variety of data on a single screen without delay, so that the efficiency of analyzing additive manufacturing data by additive manufacturing process developers and data scientists is improved and it is very helpful for correlation analysis and derivation of tendencies.

The technical concept of the disclosure may be applied to a computer-readable recording medium which records a computer program for performing the functions of the apparatus and the method according to the present embodiments. In addition, the technical idea according to various embodiments of the disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the present disclosure have been illustrated and described, the present disclosure is not limited to the above-described specific embodiments. Various changes can be made by a person skilled in the at without departing from the scope of the present disclosure claimed in claims, and also, changed embodiments should not be understood as being separate from the technical idea or prospect of the present disclosure.

1. An additive manufacturing data management method comprising:
collecting pieces of data that are generated in an additive manufacturing process;
storing the collected pieces of data; and
cross-mapping the stored pieces of data.

2. The additive manufacturing data management method of claim 1, wherein the pieces of data are generated in respective stages constituting a life cycle of additive manufacturing.

3. The additive manufacturing data management method of claim 2, wherein mapping comprises cross-mapping pieces of data that are generated in the same stage, and cross-mapping pieces of data that are generated in different stages.

4. The additive manufacturing data management method of claim 3, wherein the pieces of data generated in the respective stages comprise at least one of:
3D model information that is generated in a designing stage;
output model information, support information that are generated in a pre-processing stage;
a process parameter, a tool path, layer information, analysis information that are generated in a slicing stage;
output information, image information, environment information, sensor information, log information that are generated in an output stage; and
material property information, shape information, quality information that are generated in a post-processing stage.

5. The additive manufacturing data management method of claim 4, wherein the 3D model information comprises at least one of CAD data, 3D Scan data, a 3D authoring model,
wherein the output model information comprises at least one of a Size, Geometry, Volume, Face, Vertex, and
wherein the support information comprises at least one of Support Parameters, Overhang Angle.

6. The additive manufacturing data management method of claim 4, wherein the process parameter comprises at least one of Laser Power, Scan Speed,
wherein the tool path comprises at least one of a Path, Hatching Distance, Build Order,
wherein the layer information comprises at least one of a Layer Thickness, a Layer Area,
wherein the analysis information comprises at least one of thermal analysis, residual stress analysis, FEM analysis,
wherein the output information comprises at least one of material information, equipment information, process expert records,
wherein the image information comprises an output vision image,
wherein the environment information comprises at least one of Gas, Pressure, Temperature,
wherein the sensor information comprises a laser heat source sensor, and
wherein the log information comprises at least one of Build Plate, Laser, Recoater, Feeder.

7. The additive manufacturing data management method of claim 4, wherein the material property information comprises at least one of strength, hardness, elasticity, toughness,
wherein the shape information comprises at least one of 3D Scan, X-ray, CT, and
wherein the quality information comprises Surface Roughness.

8. The additive manufacturing data management method of claim 2, wherein the pieces of data have different data configurations, and
wherein the data configurations comprise a value, an index, a time (t), x, y, z data, a layer (l).

9. The additive manufacturing data management method of claim 1, further comprising:
searching pieces of data that are mapped to data selected by a user among the stored pieces of data; and
providing the searched pieces of data along with the data selected by the user.

10. (Canceled)

11. An additive manufacturing data management method comprising:
cross-mapping pieces of data that are generated and stored in an additive manufacturing process;
searching pieces of data that are mapped to data selected by a user among the stored pieces of data; and
providing the searched pieces of data along with the data selected by the user.

12. An additive manufacturing data management system comprising:
a storage unit configured to store pieces of data that are generated in an additive manufacturing process; and
a processor configured to cross-map the pieces of data stored in the storage unit, to search pieces of data that are mapped to data selected by a user among the stored pieces of data, and to provide the searched pieces of data along with the data selected by the user.
